(19) United States
(12) Patent Application Publication
(10) Pub. No.: US 2007/0040933 A1
(43) Pub. Date: Feb. 22, 2007

(54) Transport stream reprocessing device and data broadcasting system using the device

(75) Inventor: Beak Hoon Seong, Anyang-city, Gyeonggi-Do (KR)

Correspondence Address: SHERIDAN ROSS PC, 1560 BROADWAY, SUITE 1200, DENVER, CO, 80202, US

(73) Assignee: AIRCODE CO., LTD., Seoul (KR)

(21) Appl. No.: 11/459,244

(22) Filed: Jul. 21, 2006

(30) Foreign Application Priority Data
Jul. 22, 2005 (KR) 10-2005-0066809

(51) Int. Cl. H04N 11/02

(52) U.S. Cl. 348/385.1

(57) ABSTRACT

A program input stream reprocessing device and a data broadcasting system using the device. The program input stream reprocessing device receives and reprocesses program input streams provided by a program service provider and transmits results to the data broadcasting system. That is, additional data of a program included in the program input stream is extracted to control the packet identifier and bandwidth depending on the broadcasting service provider's condition. Also, ES (elementary stream) information to be linked with the PSI(program specific information)/PSIP(program and system information protocol) is extracted from the program input stream and is transmitted to the PSI/PSIP generator of the data broadcasting system.

### CROSS-REFERENCE TO RELATED APPLICATION

This application claims priority to and the benefit of Korean Patent Application No. 10-2005-0066809 filed in the Korean Intellectual Property Office on Jul. 22, 2005, the entire contents of which are incorporated herein by reference.

### BACKGROUND OF THE INVENTION

(a) Field of the Invention

The present invention relates to data broadcasting, and in particular, relates to a program input stream reprocessing device and a data broadcasting system using the device.

(b) Description of the Related Art

According to classification by the broadcasting committee, the data broadcasting service is defined to transmit data(characters, numbers, graphs, charts, images, and other types of information) and corresponding images and voice, and to provide various categories of additional data in cooperation with a main program or independently so that viewers may selectively view them.

In general, data broadcasting represents broadcasting for providing broadcasting programs, information, climates, stocks, news information, information provision on the Internet, and electronic commerce (EC). The data broadcasting functions to general users as a new information infrastructure, and it creates new industries with high added values related to services, devices, and contents.

The data broadcasting is classifies as various types, and the broadcasting committee classifies the data broadcasting as exclusive data broadcasting for outputting data without servicing broadcasting programs for data broadcasting and auxiliary data broadcasting for outputting the data in an auxiliary manner while servicing the broadcasting programs.

The exclusive data broadcasting provides characters, audio, and graphic data that are not related to the program contents through an additional channel, and contents that are provided in the format of exclusive data broadcasting service include news letters, magazines, Internet access, home banking, e-mail, game, and portal channel services.

The auxiliary data broadcasting is classified as linked data broadcasting for broadcasting data that are linked with the currently broadcast audio/video programs and independent data broadcasting for broadcasting data that are independent from the audio/video programs. For example, the linked data broadcasting broadcasts information on the sports players linked to a sports program when the broadcast audio/video program is a sports program, and the independent data broadcasting broadcasts data such as climates or stocks that are not related to the sports program.

In the case of producing a program for servicing auxiliary data broadcasting, a program service provider generates data broadcasting application files in a predetermined audio/video (A/V) format and transmits them to a broadcasting service provider, and the broadcasting service provider encodes the data and outputs corresponding signals. However, execution of the linked data broadcasting in the above condition generates following problems.

First, when a program service provider processes the A/V program and corresponding data into respective files and transmits the files to a broadcasting service provider, the broadcasting service provider multiplexes the files and broadcasts signals. However, since the broadcasting service providers must broadcast a plurality of programs and associated data broadcasting applications, it is not possible to check whether a data broadcasting application linked with a specific A/V program's broadcasting time is accurately output.

In this instance, since the program service provider also outputs programs to a plurality of broadcasting service providers, it is difficult to check whether the generated program is accurately broadcast by each broadcasting station.

Second, when it is needed to update the contents of the program, the program service provider generates corresponding update information, and a broadcasting service provider encodes the contents, and hence, it is not guaranteed to process the update information in real-time. Also, since there are a plurality of broadcasting service providers, the program service provider must provide an update service to the broadcasting service providers.

The above-noted problems will be further highlighted when the data broadcasting is activated and more data broadcasting programs are generated. Accordingly, the program service providers can directly perform an encoding operation so as to solve the above-noted problems.

When the program service providers perform an encoding operation, the encoded A/V programs are decoded by a decoder (e.g., an A/V integrated receiver decoder (IRD)) possessed by the broadcasting service providers and are then transmitted to a remultiplexer (Remux) to thus generate no problem, and additional information requiring data broadcasting generates problems while changing the existing system.

In detail, problems of controlling bandwidths occur because of the difference between the bandwidth set by the program service providers and the bandwidth through which the program service providers broadcast programs.

Further, the problem to convert identification information of packets used for encoding by the program service provider into information satisfying the broadcasting service provider's condition is generated. In addition, it is needed to efficiently apply program information encoded and provided by the program service provider to information processed by the broadcasting service provider.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to process programs encoded and provided by a program service provider according to broadcasting conditions. An exemplary embodiment of the present invention provides a program input stream reprocessing device being connected to a data broadcasting system and reprocessing program input streams provided by a program service provider system, wherein the program input stream is a transport stream including a plurality of packets having audio/video programs to be broadcast and corresponding additional encoded data.

The program input stream reprocessing device includes: a receiver for receiving the program input stream; a decoder for decoding the additional data included in the program input stream and acquiring first additional data information; a filter for filtering second additional data information related to data broadcasting from the additional data packets included in the program input stream; a PSI/PSIP generator linker for transmitting the acquired first additional data information to the broadcasting system to generate a PSI/PSIP (program specific information/program and system information protocol); a bandwidth controller for controlling the second additional data information's first bandwidth to be the broadcasting system's second bandwidth; a packet identifier controller for controlling the second additional data information's packet identifier value based on the broadcasting system's updated packet identifier information; and an output unit for transmitting the first additional data information with the controlled bandwidth and packet identifier to the broadcasting system so that the first additional data information may be multiplexed with the PSI/PSIP generated by the system and the audio/video data included in the program input stream.

Another exemplary embodiment of the present invention provides a data broadcasting system for reprocessing information provided by a program service provider system and outputting the reprocessed information through at least one channel, wherein the information is a program input stream that is a transport stream including a plurality of packets having audio/video programs to be broadcast and corresponding additional encoded data. The data broadcasting system includes: an audio/video decoder for extracting from the program input stream and decoding the audio/video packets; an audio/video encoder for encoding the decoded audio/video data and outputting the encoded audio/video data; a reprocessing unit for extracting additional data packets from the program input stream, controlling a bandwidth of the additional data to be a bandwidth established by the broadcasting system, controlling a packet identifier of the additional data based on updated information, and outputting the packet identifier; a PSI/PSIP generator for generating a PSI/PSIP based on the additional data included in the program input stream; a multiplexer for generating a transport stream by multiplexing information output by the reprocessing unit, the PSI/PSIP, and the audio/video data; and a transmission unit for modulating the generated transport stream and outputting the modulated transport stream.

### BRIEF DESCRIPTION OF THE DRAWINGS

FIG. 1 shows a connection diagram of a program input stream reprocessing device according to an embodiment of the present invention.

FIG. 2 shows a detailed configuration diagram of a program input stream reprocessing device according to an embodiment of the present invention.

FIG. 3 shows a configuration diagram for a data broadcasting system shown in FIG. 1.

FIG. 4 shows a program input stream reprocessing flowchart according to an embodiment of the present invention.

### DETAILED DESCRIPTION OF THE EMBODIMENTS

An exemplary embodiment of the present invention will hereinafter be described in detail with reference to the accompanying drawings. As those skilled in the art would realize, the described embodiments may be modified in various different ways, all without departing from the spirit or scope of the present invention.

A program input stream encoded by a program service provider is provided to a program input stream reprocessing device in an exemplary embodiment of the present invention. That is, the program service provider provides a program input stream having A/V programs and encoded additional data (programming information, data contents formation information, and encoding information) related to the A/V program to the program input stream reprocessing device, and the program input stream reprocessing device reprocesses the program input stream and transmits the reprocessed program input stream to the data broadcasting system of the broadcasting service provider.

The program input stream reprocessing device can be realized to be included in the broadcasting service provider's data broadcasting system, or can be realized to be separately realized from the data broadcasting system.

The program input stream includes a plurality of packets including encoded video data, audio data, and additional encoded data. In detail, for example, the video data are encoded by the MPEG-2 scheme to be video elementary streams (ES's), and the audio data are encoded by the AC3 (Dolby digital sound format) to be audio ES's. The video ES and the audio ES are divided by variable sizes, headers are assigned to the video and audio ES's to be thus converted into packetized elementary stream (PES) packets, and the video and audio PES packets are multiplexed together with program and system information (PSI) and program and system information provider (PSIP) sections to be thus output to transfer streams (TS's) having a plurality of TS packets. In addition, the TS includes an object carousel (OC) having an application program and corresponding data, and TS packet configuring an application information table (AIT.)

Each packet configuring the TS has a packet identifier (PID) for identifying packets, and the data length of the packet is a fixed length, and hence, a single module can be processed as a plurality of packets In this case, the same packet identifier (PID) can be assigned to the packets.

The PSI is information included in the MPEG, and it provides program specification information on the method of selecting a program from among a plurality of programs, selecting a packet, and decoding the same. The PSI has four tables including a program map table (PMT) for describing a program ID, a PID list of TS packets for transmitting respective bit sequences such as video and audio configuring the program, and additional information; a program association table (PAT) having a PID value of the PMT for describing parts of each program, the PAT being transmitted by the packet having the PID of “0”; a conditional access table (CAT) for allowing a registered user to decode and reproduce scrambled bit sequences so as to control the reproduction; and a network information table (NIT) having physical network information on a region for receiving data.

Also, the PSIP is a small set of tables that are designed to process all the TSs needed for broadcasting, and the PSIP has information on the system and event levels for virtual channels that are transmitted to the TSs. The PSIP has a system time table (STT) for having information on the current date and time, a master guide table (MGT) for having PID values and versions of the tables except those of the STT and allowing to find values of an event information table (EIT) and an extended text table (ETT), a virtual channel table (VCT) for having information on the virtual channel (including a channel name, a channel PTC number, a stream component, and a type), a rating region table (RRT) for including contents grades, and EIT for providing a program title of at least three hours of all the channels in the VCT and being used for the EPG, and an ETT for providing information on the program outline and background.

Since the program service provider directly encodes the A/V program to be broadcast and various additional data related to the program, it is needed to adequately control the program input stream to satisfy the broadcasting condition.

Therefore, the program input stream reprocessing device according to the embodiment of the present invention updates the additional data with new information or controls the broadcasting bandwidth when receiving encoded program input stream from the program service provider.

Particularly, the output bandwidths of the OC and the TS packets configuring the AIT are controlled depending on the broadcasting condition, and ES information is applied in real-time to the PSI/PSIP. The PID of the TS packets used for encoding the data broadcasting by the program service provider are controlled to satisfy the broadcasting condition. In detail, the PID of packets used by the program service provider for data broadcasting can be the PID that is already used by the broadcasting service provider. When many programs are broadcast by using the same PID, broadcasting accidents may occur, and hence, the broadcasting service provider converts the PID of packets of the program input streams provided by the program service provider into the PID that satisfies the broadcasting service provider's condition.

Also, the OC related to data broadcasting and the transmission stream configuring the AIT can be separated from the program input stream received from the program service provider.

In detail, PMT information on the TS packets related to data broadcasting is controlled to be applied to the PSI/PSIP, and the OC related to data broadcasting and the TS configuring the AIT are separated from the TSs related to data broadcasting so as to correct the bandwidth, packet ID information, and PSI/PSIP information.

A program input stream reprocessing device structure and operation thereof according to an embodiment of the present invention will now be described.

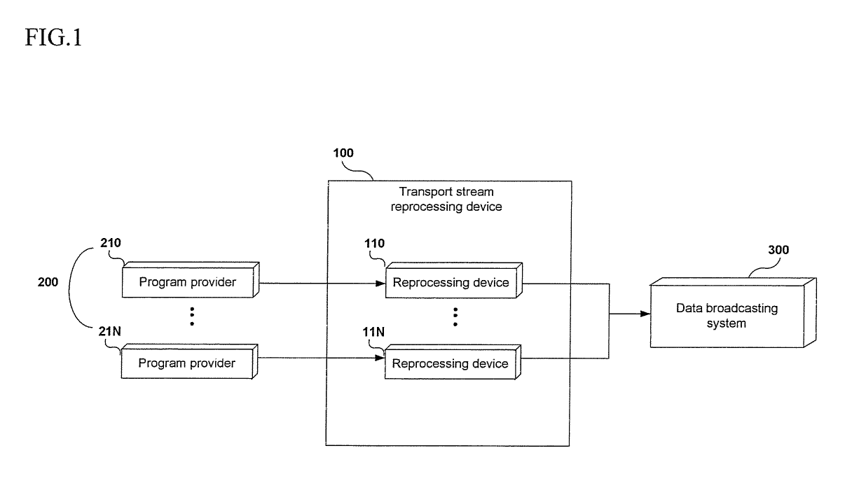

FIG. 1 shows a connection diagram of a program input stream reprocessing device according to an embodiment of the present invention.

The program input stream reprocessing device 100 is connected to systems (210 . . . 21N, referred to as 200 hereinafter for ease of description) of a plurality of program service providers, and a data broadcasting systems 300, as shown in FIG. 1.

The program input stream reprocessing device 100 is connected one by one to the program service provider systems 200 so that each program service provider may process the program input streams provided by the program service provider systems 200, and differing from this, it is possible to realize the same device 100 such that the device 100 may receive the program input streams provided by the program service provider system 200 and process the program input streams.

Also, the program input stream reprocessing device 100 is realized to be separate from the data broadcasting system 300, and the present invention is not restricted to this embodiment.

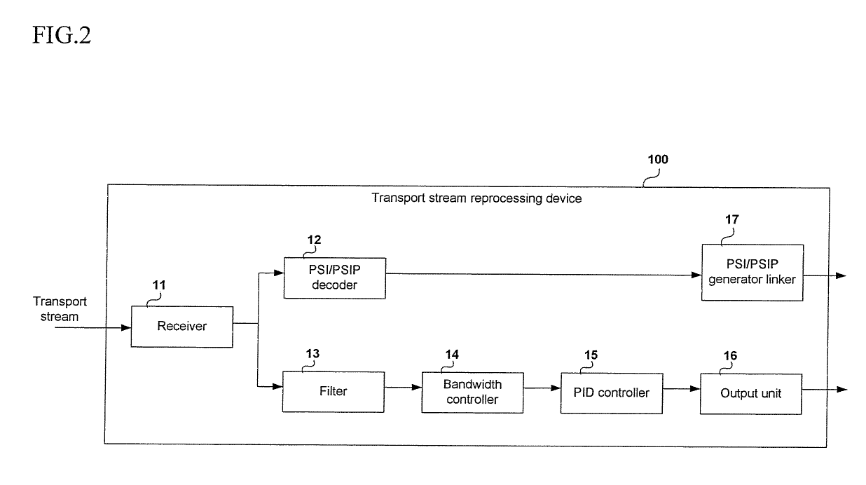

FIG. 2 shows a program input stream reprocessing device according to an embodiment of the present invention. For better comprehension and ease of description, the program input stream reprocessing device will be referred to as a stream reprocessing device.

The stream reprocessing device separates additional data TS packets from the program input streams provided by the program service provider system 200 and controls them. For this purpose, as shown in FIG. 2, the stream reprocessing device includes a receiver 11 for program input streams from a program service provider, a PSI/PSIP decoder 12 for extracting first additional data information and the OC/AIT's PMT information from the received program input streams, a filter 13 for filtering second additional data information from the received program input streams according to the OC/AIT's PMT information provided by the PSI/PSIP decoder 12, a bandwidth controller 14 for controlling the extracted second additional data information's bandwidth according to the broadcasting service provider's broadcasting condition, a PID controller 15 for controlling the second additional data information's PID according to the broadcasting service provider's (data broadcasting system's) broadcasting condition, an output unit 16 for outputting the second additional data information to the data broadcasting system 300, and a PSI/PSIP generator linker 17 for transmitting the first additional data information to the data broadcasting system 300. The PSI/PSIP generator linker 17 provides the first additional data information to a PSI/PSIP generator of the data broadcasting system 300.

The stream reprocessing device 100 separates additional data TS packets from the applied program input streams except the audio/video TS packets, controls packet identification information and bandwidth included therein, provides controlled data to the data broadcasting system 300, and transmits ES information from among the separated TS packets to the PSI/PSIP generator. In detail, the stream reprocessing device 100 extracts PSI/PSIP information (the first additional data information) from the program input stream and transmits the information to the PSI/PSIP generator. Also, the stream reprocessing device 100 separates the OC including an application program and corresponding data, and information (the second additional data information) configuring the AIT from the program input stream, and transmits the separated data to the data broadcasting system 300.

The broadcasting service provider's data broadcasting system 300 processes the program input streams provided by the program service provider based on the information provided by the stream reprocessing device 100, and transmits the processed stream to a user terminal (not shown.)

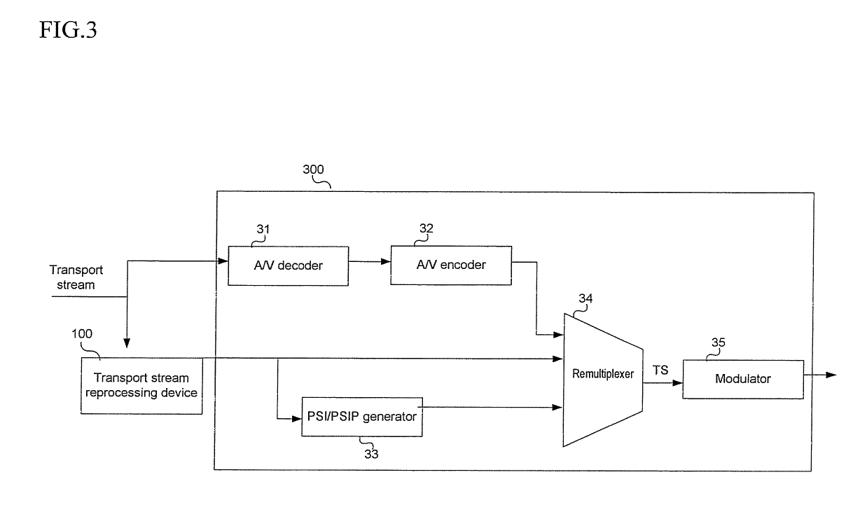

FIG. 3 shows a configuration of the data broadcasting system 300. A connection state between the stream reprocessing device and the data broadcasting system can be found in detail from FIG. 3.

As shown in FIG. 3, the data broadcasting system 300 includes an A/V decoder 31 for receiving the program input stream from the program service provider, an A/V encoder 32 for encoding the signals output by the A/V decoder 31, a PSI/PSIP generator 33 for generating PSI/PSIP based on the signals output by the stream reprocessing device 100, a remultiplexer 34 for multiplexing the signals provided through the A/V encoder, the stream reprocessing device 100, and the PSI/PSIP generator 33, and a modulator 35 for modulating the signals output by the remultiplexer 34.

The A/V decoder 31 separates the audio/video TS packets from the applied program input stream and transmits the stream to the A/V encoder 32.

The PSI/PSIP generator 33 generates a PSI/PSIP based on the first additional data information, particularly, ES information provided by the stream reprocessing device 100, and transmits the PSI/PSIP to the remultiplexer 34. In this instance, ES information can be extracted from the PMT in the PSI, it can be extracted by referring to the VCT in the PSIP, and it can be extracted by analyzing the PID.

On receiving the audio/video TS packets, data broadcasting OC/AIT information, and ES information, the remultiplexer 34 remultiplexes them and outputs remultiplexed signals to the modulator 35.

An operation by the stream reprocessing device according to an embodiment of the present invention will now be described based on the above-noted configuration.

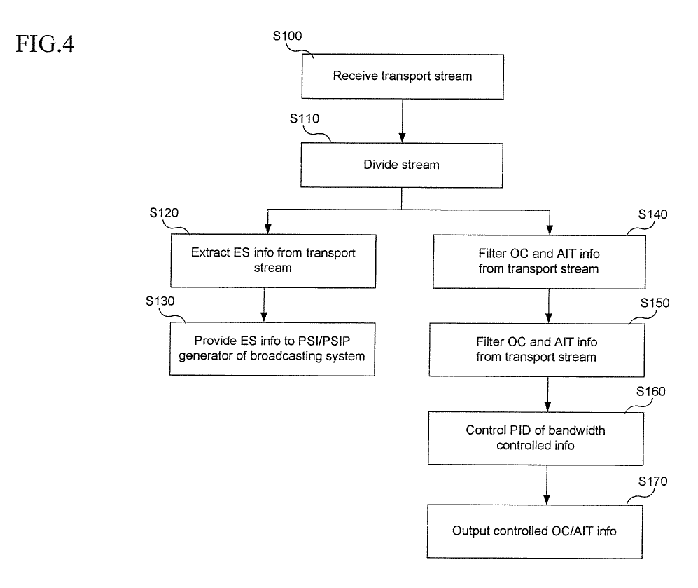

FIG. 4 shows a program input stream reprocessing process according to an embodiment of the present invention.

On receiving encoded program input streams from a program service provider (S100), the receiver 11 transmits the program input stream to the filter 13 and the PSI/PSIP decoder 12 (S110).

The PSI/PSIP decoder 12 analyzes the encoded additional data TS packets from the program input streams that are encoded by the transfer protocol defined in the data broadcasting transfer protocol and are transmitted, and extracts ES information. In detail, the PSI/PSIP decoder 12 extracts ES information by referring to one of the PSI's PMT and the PSIP's VCT or analyzing the PID, and extracts the OC/AIT's PMT information (S120). The extract ES information is provided to the PSI/PSIP generator linker 17, and the PSI/PSIP generator linker 17 provides the ES information to the PSI/PSIP generator 33 of the data broadcasting system 300 of the broadcasting service provider (S130). In this instance, the PSI/PSIP generator linker 17 and the PSI/PSIP generator 33 provide information by using the TCP(transmission control protocol)/IP (internet protocol) or other communication methods.

The filter 13 filters second additional data information, that is, information on the OC including application programs and corresponding data and the AIT from among the additional data TS packets of the program input streams (S140). The OC represents a digital broadcasting's data transmission method and transmits files configuring the data broadcasting application, and the AIT is a table for showing additional information for a receiver to perform an application and realize broadcasting, including, for example, an application title and a start file. In the embodiment of the present invention, in order to efficiently repeat the data broadcasting, OC and AIT streams on data broadcasting are extracted from the streams including additional data for A/V and data broadcasting to control the bandwidth and the PID based on the extracted streams, that is, OC and AIT information.

The filtered OC and AIT information is provided to the bandwidth controller 14, and the bandwidth controller 14 controls the bandwidth of the extracted OC/AIT information according to the broadcasting service provider's broadcasting condition (S150). That is, the first bandwidth of the second additional data information (OC/AIT information) provided by the program service provider is changed with a second bandwidth of the data broadcasting system 300 according to the embodiment of the present invention. The OC repeatedly outputs the same data with a specific period, and for example, the bandwidth controller 14 receives packets (packets having the first bandwidth) on the OC/AIT information configuring a period and repeatedly retransmits the packets according to a period satisfying a new second bandwidth to thus control the bandwidth.

The PID controller 15 receives OC/AIT information, controls PID values on the TS packets configuring the information according to the broadcasting system 300, and outputs data to the output unit 16 (S160). The PID controller 15 uses a mapping table to control the PID value on the TS packets configuring the OC/AIT information to be a value that corresponds to the broadcasting service provider's data broadcasting system 300. The mapping table has information on how to control the PID value to have a new PID value. Table 1 shows an exemplified mapping table.

TABLE 1

| Original PID | Updated PID |
|---|---|
| 100 | 200 |
| 201 | 201 |

Therefore, the PID controller 15 determines whether the PID values of packets of the input OC and AIT are found in the original PID value field of the mapping table, and when they are found, the PID controller changes the PIDs of the input packets with new PID values stored in the update PID field corresponding to the original PID field. When the PID values of the input packets are not found in the original PID field of the mapping table, the PID controller 15 uses the PID values of the input packets. For example, when the PID value of the input OC packet is given as 100, the PID controller 15 changes the PID value from 100 to 200 by referring to the mapping table shown in Table 1, and when the PID value of the input OC packet is given as 150, the PID controller 15 maintains the value. The above-noted control of PID values prevents broadcasting accidents in which programs are not reproduced in the receiver by a plurality of programs having the same PID.

When information on the changed bandwidth and PID is input, the output unit 16 processes the information to be signals in the asynchronous serial interface format or communication signals, and outputs the same to the remultiplexer 34 of the data broadcasting system 300. In this instance, the PID value is controlled after the bandwidth is controlled, and differing from this, the bandwidth value can be controlled after the PID is controlled. That is, the order of controlling bandwidth and the PID value is not restricted.

As described above, the stream reprocessing device 100 controls the additional data included in the encoded data broadcasting application provided by the program service provider according to the broadcasting condition of the broadcasting system 300, and outputs controlled signals to the remultiplexer 34.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. For example, the above-described process can be realized as a program that is stored on a computer-readable recording medium. The recording medium includes any types of recording devices for storing computer-readable data, for example, a CD-ROM, a magnetic tape, and a floppy disk, and also, a carrier wave (e.g., Internet transmission) type device.

Accordingly, subsequent effects are provided according to the embodiment of the present invention.

First, the output bandwidths of the OC and the TS packets configuring the AIT transmitted by the program service provider can be controlled to satisfy respective broadcasting service providers' broadcasting conditions.

Second, the PIDs of TS packets used for encoding OC and bidirectional data broadcasting in the program service provider's system can be controlled to be PIDs satisfying the broadcasting service provider's condition.

Third, ES information on the TSs related to data broadcasting can be transmitted in real-time to the PSI/PSIP generator.

Fourth, the OC related to data broadcasting and the TS packets configuring the AIT can be easily separated from the program input streams provided by the program service provider.

What is claimed is:

1. A program input stream reprocessing device being connected to a data broadcasting system and reprocessing program input streams provided by a program service provider system, wherein
the program input stream is a transport stream including a plurality of packets having audio/video programs to be broadcast and corresponding additional encoded data,
the program input stream reprocessing device comprising:
a receiver for receiving the program input stream;
a decoder for decoding the additional data included in the program input stream and acquiring first additional data information;
a filter for filtering second additional data information related to data broadcasting from the additional data packets included in the program input stream;
a PSI/PSIP generator linker for transmitting the acquired first additional data information to the broadcasting system to generate a PSI/PSIP (program specific information/program and system information protocol);
a bandwidth controller for controlling the second additional data information's first bandwidth to be the broadcasting system's second bandwidth;
a packet identifier controller for controlling the second additional data information's packet identifier value based on the broadcasting system's updated packet identifier information; and
an output unit for transmitting the first additional data information with the controlled bandwidth and packet identifier to the broadcasting system so that the first additional data information may be multiplexed with the PSI/PSIP generated by the system and the audio/video data included in the program input stream.

2. The program input stream reprocessing device of claim 1, wherein
the packet identifier controller further includes a mapping table for storing a mapped second packet identifier having a packet identifier value updated for each first packet identifier, and the packet identifier controller changes the packet identifier with a second packet identifier when a packet identifier of the first additional data information is provided in the mapping table, and it maintains the packet identifier of the first additional data information or discards the corresponding packet when the packet identifier the first additional data information is not provided in the mapping table.

3. The program input stream reprocessing device of claim 1, wherein
the first additional data information is object carousel/application information table (OC/AIT) information on data broadcasting, and
the second additional data information is one of elementary stream (ES) information of a program map table (PMT) describing program components, ES information extracted from the VCT in the PSIP, and ES information extracted from the PID.

4. The program input stream reprocessing device of claim 2, wherein
the first additional data information is object carousel/application information table (OC/AIT) information on data broadcasting, and
the second additional data information is one of elementary stream (ES) information of a program map table (PMT) describing program components, ES information extracted from the VCT in the PSIP, and ES information extracted from the PID.

5. The program input stream reprocessing device of claim 3, wherein
the first additional data information is object carousel/application information table (OC/AIT) information on data broadcasting, and
the second additional data information is one of elementary stream (ES) information of a program map table (PMT) describing program components, ES information extracted from the VCT in the PSIP, and ES information extracted from the PID.

6. A data broadcasting system for reprocessing information provided by a program service provider system and outputting the reprocessed information through at least one channel, wherein
the information is a program input stream that is a transport stream including a plurality of packets having audio/video programs to be broadcast and corresponding additional encoded data, and
the data broadcasting system includes: an audio/video decoder for extracting from the program input stream and decoding the audio/video packets;
an audio/video encoder for encoding the decoded audio/video data and outputting the encoded audio/video data;
a reprocessing unit for extracting additional data packets from the program input stream, controlling a bandwidth of the additional data to be a bandwidth established by the broadcasting system, controlling a packet identifier of the additional data based on updated information, and outputting the packet identifier;
a PSI/PSIP generator for generating a PSI/PSIP based on the additional data included in the program input stream;
a multiplexer for generating a transport stream by multiplexing information output by the reprocessing unit, the PSI/PSIP, and the audio/video data; and
a transmission unit for modulating the generated transport stream and outputting the modulated transport stream.

7. The data broadcasting system of claim 6, wherein
the reprocessing unit comprises:
a receiver for receiving the program input stream;
a decoder for decoding additional data included in the program input stream and acquiring ES information;
a PSI/PSIP generator linker for transmitting the acquired ES information to the PSI/PSIP generator;
a filter for filtering OC/AIT information packets related to data broadcasting from the additional data packets included in the program input stream;
a bandwidth controller for controlling the filtered packets' first bandwidths to be the broadcasting system's second bandwidth;
a packet identifier controller for controlling the filtered packets' packet identifier values based on updated packet identifier information of the broadcasting system; and
an output unit for transmitting the packets with the controlled bandwidth and packet identifiers to the multiplexer.
